(19) United States
(12) Patent Application Publication
(10) Pub. No.: US 2008/0256634 A1
(43) Pub. Date: Oct. 16, 2008

(54) TARGET DATA DETECTION IN A STREAMING ENVIRONMENT

(76) Inventor: Peter Pichler, Abingdon (GB)

Correspondence Address: STRATEGIC PATENTS P.C.., C/O PORTFOLIOIP, P.O. BOX 52050, MINNEAPOLIS, MN, 55402, US

(21) Appl. No.: 12/048,937

(22) Filed: Mar. 14, 2008

Related U.S. Application Data
(60) Provisional application No. 60/894,866, filed on Mar. 14, 2007.

(51) Int. Cl. G06F 21/00

(52) U.S. Cl. 726/23

(57) ABSTRACT

In embodiments of the present invention improved capabilities are described for a data stream scanner. The present invention may provide for a data portion received in association with a data stream, and the data portion may be analyzed to make an assessment. An identity pool may then be selected from a universe of identities based on the assessment, and identities from the identity pool may be selected in a scanning process to analyze the data stream. Further, an unmatched identity may remove the identity from the pool upon finding that the unmatched identity does not match data in the data stream.

### CROSS-REFERENCE TO RELATED APPLICATIONS

This application claims the benefit of the following provisional application, which is hereby incorporated by reference in its entirety:

U.S. Provisional App. No. 60/894,866 filed Mar. 14, 2007.

### BACKGROUND

1. Field

The present invention is related to secure computing, and more specifically relating to the scanning of data in a streaming environment.

2. Description of the Related Art

One aspect of secure computing is the scanning of data as it is streamed, such as scanning for malware present in a stream of data. One method for scanning a file that is being streamed may be to write the entire file into memory and perform a scan in a manner similar to the scanning of non-streaming data. This method however may be slow and require large memory allocations wherever the scan is to be performed, and many components channeling streaming data may not normally have such memory. Another method of scanning streaming data may be to perform pattern matching on the data as it passes, such as pattern matching each packet as it passes through the system. Pattern matching alone however may fail to identify much of the malware that may be present in the streamed data. Therefore, there is a need for improved methods of scanning data in a streaming environment.

### SUMMARY

In embodiments, data may be scanned as it is streamed through a computing facility. The data may be intercepted and scanned in portions as it flows through the computing facility. The scanning process may perform an evaluation of the data through the use of a pool of identities. The pool of identities may be selected from a universe of identities to limit the number of identities to be used in the scan. The pool of identities may be selected based on an examination of a portion of the data stream. By intelligently limiting the number of identities used in the scan, the scan can be shortened and this can lead to a significant increase in the computing performance and/or bandwidth.

In embodiments, a data portion may be received associated with a data stream, and the data portion may be analyzed to make an assessment. An identity pool may then be selected from a universe of identities based on the assessment, and identities from the identity pool may be selected in a scanning process to analyze the data stream. Further, an unmatched identity may remove the identity form the pool upon finding that the unmatched identity may not match data in the data stream, and a matched identity may be removed from the identity pool upon finding that the matched identity matches data in the data stream.

In embodiments, the scanning process may analyze each byte of the data stream, a plurality of byte portions from the data stream, a pattern of bytes from the data stream, and the like. In embodiments, the identity may be a byte code, where the process of scanning may involve executing the identities in the identity pool, at least one identity executing a matching process, at least one identify executing a hashing process, and the like. At least one identity may execute a determination process, wherein a decision about the data stream may be made following its execution. In embodiments, the identity may be a data pattern, where the process of scanning may involve comparing the identities in the identity pool to data from the data stream. In embodiments, the scanning process may be attempting to identify malware, identify information in accordance to a corporate policy, identify a file, and the like.

These and other systems, methods, objects, features, and advantages of the present invention will be apparent to those skilled in the art from the following detailed description of the preferred embodiment and the drawings. All documents mentioned herein are hereby incorporated in their entirety by reference.

### BRIEF DESCRIPTION OF THE FIGURES

The invention and the following detailed description of certain embodiments thereof may be understood by reference to the following figures:

FIG. 1 depicts a block diagram of the threat management facility providing protection to an enterprise against a plurality of threats.

FIG. 2 depicts an embodiment of a block diagram for the present invention.

FIG. 3 depicts an embodiment of a process flow diagram for the invention.

FIG. 4 depicts a flow chart of a pool of identities scanning a data stream in an embodiment of the invention.

FIG. 5 depicts an example of how a pool of identities may be selected.

FIG. 6 depicts an example of how a pool of identities may be used to find an identity match in a string of data.

FIG. 7 depicts an embodiment of a process flow diagram for the invention.

FIG. 8 depicts a flow chart of a pool of identities scanning a data stream in an embodiment of the invention.

FIG. 9 depicts an embodiment of a process flow for the invention.

FIG. 10 depicts an embodiment of a process flow for the invention.

While the invention has been described in connection with certain preferred embodiments, other embodiments would be understood by one of ordinary skill in the art and are encompassed herein.

All documents referenced herein are hereby incorporated by reference.

### DETAILED DESCRIPTION

An aspect of the present invention relates to corporate policy management and their implementation through a unified threat management facility 100. As will be explained in more detail below, a threat management facility 100 is used to protect computer assets from many threats, both computer generated threats and user generated threats. The threat management facility 100 is multi-dimensional in that it is designed to protect corporate assets from a variety of threats and it is adapted to learn about threats in one dimension (e.g. worm detection) and apply the knowledge in another dimension (e.g. spam detection). Corporate policy management is one of the dimensions for which the threat management facility can control. The corporation may institute a policy that prevents certain people (e.g. employees, groups of employees, types of employees, guest of the corporation, etc.) from accessing certain types of computer programs. For example, the corporation may elect to prevent its accounting department from using a particular version of an instant messaging service or all such services. In this example, the policy management facility 112 may be used to update the policies of all corporate computing assets with a proper policy control facility or it may update a select few. By using the threat management facility 100 to facilitate the setting, updating and control of such policies the corporation only needs to be concerned with keeping the threat management facility 100 up to date on such policies. The threat management facility 100 can take care of updating all of the other corporate computing assets.

It should be understood that the threat management facility 100 may provide multiple services and policy management may be offered as one of the services. We will now turn to a description of the threat management system 100.

Over recent years, malware has become a major problem across the internet 154. From both technical and user perspectives the categorization of a specific threat type, such as whether it is a virus, worm, spam, phishing exploration, spyware, adware, or the like, is becoming reduced in significance. The threat, no matter how it's categorized, may need to be stopped at all points of the enterprise facility 102, including laptop, desktop, server facility 142, gateway, and the like. Similarly, there may be less and less benefit to the user in having different solutions for known and unknown threats. As such, a consolidated threat management facility 100 may need to be applied to the same set of technologies and capabilities for all threats. The threat management facility 100 may provide a single agent on the desktop, and a single scan of any suspect file. This approach may eliminate the inevitable overlaps and gaps in protection caused by treating viruses and spyware as separate problems, while simultaneously simplifying administration and minimizing desktop load. As the number and range of types of threats has increased, so may have the level of connectivity available to all IT users. This may have lead to a rapid increase in the speed at which threats may move. Today, an unprotected PC connected to the internet 154 may be infected quickly, say within 10 minutes, which may require acceleration for the delivery of threat protection. Where once, monthly updates may have been sufficient, the threat management facility 100 may automatically and seamlessly update its product set against spam and virus threats quickly, for instance, every five minutes, every minute, continuously, or the like. Analysis and testing may be increasingly automated, and also may be performed more frequently; for instance, it may be completed in 15 minutes, and may do so without compromising quality. The threat management facility 100 may also extend techniques that may have been developed for virus and malware protection, and provide them to enterprise facility 102 network administrators to better control their environments. In addition to stopping malicious code, the threat management facility 100 may provide policy management that may be able to control legitimate applications, such as VoIP, instant messaging, peer-to-peer file-sharing, and the like, that may undermine productivity and network performance within the enterprise facility 102.

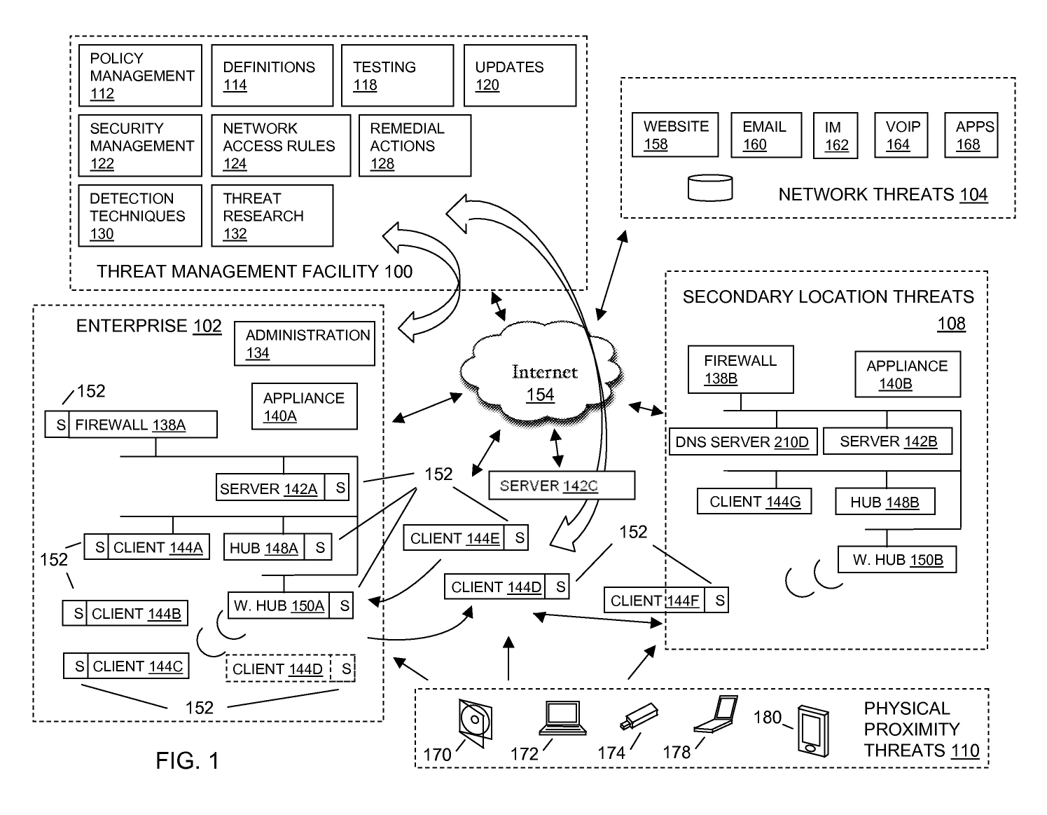

The threat management facility 100 may provide an enterprise facility 102 protection from computer-based malware, including viruses, spyware, adware, Trojans, intrusion, spam, policy abuse, uncontrolled access, and the like, where the enterprise facility 102 may be any entity with a networked computer-based infrastructure. In an embodiment, FIG. 1 may depict a block diagram of the threat management facility providing protection to an enterprise against a plurality of threats. The enterprise facility 102 may be corporate, commercial, educational, governmental, or the like, and the enterprise facility's 102 computer network may be distributed amongst a plurality of facilities, and in a plurality of geographical locations. The threat management facility 100 may include a plurality of functions, such as security management facility 122, policy management facility 112, update facility 120, definitions facility 114, network access rules facility 124, remedial action facility 128, detection techniques facility 130, testing facility 118, threat research facility 132, and the like. In embodiments, the threat protection provided by the threat management facility 100 may extend beyond the network boundaries of the enterprise facility 102 to include enterprise facility 102 client facility's 144 that have moved into network connectivity not directly associated or controlled by the enterprise facility 102. Threats to enterprise facility 102 client facilities 144 may come from a plurality of sources, such as from network threats 104, physical proximity threats 110, secondary location threats 108, and the like. In embodiments, the threat management facility 100 may provide an enterprise facility 102 protection from a plurality of threats to multiplatform computer resources in a plurality of locations and network configurations, with an integrated system approach.

In embodiments, the threat management facility 100 may be provided as a stand-alone solution. In other embodiments, the threat management facility 100 may be integrated into a third-party product. An application programming interface (e.g. a source code interface) may be provided such that the threat management facility 100 may be integrated. For instance, the threat management facility 100 may be stand-alone in that it provides direct threat protection to an enterprise or computer resource, where protection is subscribed to directly with the threat management facility 100. Alternatively, the threat management facility may offer protection indirectly, through a third-party product, where an enterprise may subscribe to services through the third-party product, and threat protection to the enterprise may be provided by the threat management facility 100 through the third-party product.

The security management facility 122 may include a plurality of elements that provide protection from malware to enterprise facility 102 computer resources, including endpoint security and control, email security and control, web security and control, control of unauthorized users, control of guest and non-compliant computers, and the like. The security management facility 122 may be a software application that may provide malicious code and malicious application protection to a client facility 144 computing resource. The security management facility 122 may have the ability to scan the client facility 144 files for malicious code, remove or quarantine certain applications and files, prevent certain actions, perform remedial actions and perform other security measures. In embodiments, scanning the client facility 144 may include scanning some or all of the files stored to the client facility 144 on a periodic basis, may scan applications once the application has been requested to execute, may scan files as the files are transmitted to or from the client facility 144, or the like. The scanning of the applications and files may be to detect known malicious code or known unwanted applications. In an embodiment, new malicious code and unwanted applications may be continually developed and distributed, and updates to the known code database may be provided on a periodic basis, on a demand basis, on an alert basis, or the like.

In an embodiment, the security management facility 122 may provide for email security and control, where security management may help to eliminate spam, viruses, spyware and phishing, control of email content, and the like. The security management facilities 122 email security and control may protect against inbound and outbound threats, protect email infrastructure, prevent data leakage, provide spam filtering, and the like. In an embodiment, security management facility 122 may provide for web security and control, where security management may help to detect or block viruses, spyware, malware, unwanted applications, help control web browsing, and the like, which may provide comprehensive web access control enabling safe, productive web browsing. Web security and control may provide internet use policies, reporting on suspect devices, security and content filtering, active monitoring of network traffic, URI filtering, and the like. In an embodiment, the security management facility 122 may provide for network access control, which may provide control over network connections. Network control may stop unauthorized, guest, or non-compliant systems from accessing networks, and may control network traffic that may not be bypassed from the client level. In addition, network access control may control access to virtual private networks (VPN), where VPNs may be a communications network tunneled through another network, establishing a logical connection acting as a virtual network. In embodiments, a VPN may be treated in the same manner as a physical network.

In an embodiment, the security management facility 122 may provide for host intrusion prevention through behavioral based protection, which may guard against unknown threats by analyzing behavior before software code executes. Behavioral based protection may monitor code when it runs and intervene if the code is deemed to be suspicious or malicious. Advantages of behavioral based protection over runtime protection may include code being prevented from running, whereas runtime protection may only interrupt code that has already partly executed; behavioral protection may identify malicious code at the gateway or on the file servers and deletes it before reaching end-point computers; and the like.

In an embodiment, the security management facility 122 may provide for reputation filtering, which may target or identify sources of known malware. For instance, reputation filtering may include lists of URIs of known sources of malware or known suspicious IP addresses, or domains, say for spam, that when detected may invoke an action by the threat management facility 100, such as dropping them immediately. By dropping the source before any interaction can initiate, potential threat sources may be thwarted before any exchange of data can be made.

In embodiments, information may be sent from the enterprise back to a third party, a vendor, or the like, which may lead to improved performance of the threat management facility 100. For example, the types, times, and number of virus interactions that a client experiences may provide useful information for the preventions of future virus threats. This type of feedback may be useful for any aspect of threat detection. Feedback of information may also be associated with behaviors of individuals within the enterprise, such as being associated with most common violations of policy, network access, unauthorized application loading, unauthorized external device use, and the like. In embodiments, this type of information feedback may enable the evaluation or profiling of client actions that are violations of policy that may provide a predictive model for the improvement of enterprise policies.

In an embodiment, the security management facility 122 may provide for the overall security of the enterprise facility 102 network or set of enterprise facility 102 networks, may provide updates of malicious code information to the enterprise facility 102 network, and associated client facilities 144. The updates may be a planned update, an update in reaction to a threat notice, an update in reaction to a request for an update, an update based on a search of known malicious code information, or the like. The administration facility 134 may provide control over the security management facility 122 when updates are performed. The updates may be automatically transmitted without an administration facility's 134 direct control, manually transmitted by the administration facility 134, or the like. The security management facility 122 may include the management of receiving malicious code descriptions from a provider, distribution of malicious code descriptions to enterprise facility 102 networks, distribution of malicious code descriptions to client facilities 144, or the like. In an embodiment, the management of malicious code information may be provided to the enterprise facility's 102 network, where the enterprise facility's 102 network may provide the malicious code information through the enterprise facility's 102 network distribution system.

The threat management facility 100 may provide policy management facility 112 that may be able to block non-malicious applications, such as VoIP 164, instant messaging 162, peer-to-peer file-sharing, and the like, that may undermine productivity and network performance within the enterprise facility 102. The policy management facility 112 may be a set of rules or policies that may indicate enterprise facility 102 access permissions for the client facility 144, such as access permissions associated with the network, applications, external computer devices, and the like. The policy management facility 112 may include a database, a text file, a combination of databases and text files, or the like. In an embodiment, a policy database may be a block list, a black list, an allowed list, a white list, or the like that may provide a list of enterprise facility 102 external network locations/applications that may or may not be accessed by the client facility 144. The policy management facility 112 may include rules that may be interpreted with respect to an enterprise facility 102 network access request to determine if the request should be allowed. The rules may provide a generic rule for the type of access that may be granted; the rules may be related to the policies of an enterprise facility 102 for access rights for the enterprise facility's 102 client facility 144. For example, there may be a rule that does not permit access to sporting websites. When a website is requested by the client facility 144, a security facility may access the rules within a policy facility to determine if the requested access is related to a sporting website. In an embodiment, the security facility may analyze the requested website to determine if the website matches with any of the policy facility rules.

The policy management facility 112 may be similar to the security management facility 122 but with the distribution of enterprise facility 102 wide access rules and policies that may maintain control of the access of client facility 144 to enterprise facility 102 network resources. The policies may be defined for application type, subset of application capabilities, organization hierarchy, computer facility type, user type, network location, time of day, connection type, or the like. Policies may be maintained by the administration facility 134, through the threat management facility 100, in association with a third party, or the like. For example, a policy may restrict IM 162 activity to only support personnel for communicating with customers. This may allow communication for departments requiring access, but may maintain the network bandwidth for other activities by restricting the use of IM 162 to only the personnel that need access to IM 162 in support of the enterprise facility 102. In an embodiment, the policy management facility 112 may be a standalone application, may be part of the policy management facility 112 network server facility 142, may be part of the enterprise facility 102 network, may be part of the client facility 144, or the like.

In embodiments, the threat management facility 100 may provide configuration management, which may be similar to policy management, but may specifically examine the configuration set of applications, operating systems, hardware, and the like, and managing changes to their configurations. Assessment of a configuration may be made against a standard configuration policy, detection of configuration changes, remediation of improper configuration, application of new configurations, and the like. An enterprise may keep a set of standard configuration rules and policies which may represent the desired state of the device. For example, a client firewall may be running and installed, but in the disabled state, where remediation may be to enable the firewall. In another example, the enterprise may set a rule that disallows the use of USB disks, and sends a configuration change to all clients, which turns off USB drive access via a registry.

In embodiments, the threat management facility 100 may also provide for the removal of applications that may interfere with the operation of the threat management facility 100, such as competitor products that may also be attempting similar threat management functions. The removal of such products may be initiated automatically whenever such products are detected. In the case where such applications are services are provided indirectly through a third-party product, the application may be suspended until action is taken to remove or disable the third-party product's protection facility.

Threat management against a sometimes quickly evolving malware environment may require timely updates, and the update management facility 120 may be provided by the threat management facility 100 enterprise facility 102. In addition, a policy management facility 112 may also require update management (e.g. as provided by the update facility 120 herein described), as the enterprise facility 102 requirements for policies change enterprise facility 102 server facility 142 enterprise facility 102 client facility 144 server facility 142 enterprise facility 102. The update management for the security facility 122 and policy management facility 112 may be provided directly by the threat management facility 100, such as by a hosted system or in conjunction with the administration facility 134. In embodiments, the threat management facility 100 may provide for patch management, where a patch may be an update to an operating system, an application, a system tool, or the like, where one of the reasons for the patch is to reduce vulnerability to threats.

In embodiments, the security facility 122 and policy management facility 112 may push information to the enterprise facility 102 network and/or client facility 144, the enterprise facility 102 network and/or client facility 144 may pull information from the security facility 122 and policy management facility 112 network server facilities 142, there may be a combination of pushing and pulling of information between the security facility 122 and the policy management facility 112 network servers 142, enterprise facility 102 network, and client facilities 144, or the like. For example, the enterprise facility 102 network and/or client facility 144 may pull information from the security facility 122 and policy management facility 112 network server facility 142 may request the information using the security facility 122 and policy management facility 112 update module; the request may be based on a certain time period, by a certain time, by a date, on demand, or the like. In another example, the security facility 122 and policy management facility 112 network servers 142 may push the information to the enterprise facility's 102 network and/or client facility 144 by providing notification that there are updates available for download and then transmitting the information. The combination of the security management 122 network server facility 142 and security update module may function substantially the same as the policy management facility 112 network server and policy update module by providing information to the enterprise facility 102 network and the client facility 144 in a push or pull method. In an embodiment, the policy management facility 112 and the security facility 122 management update modules may work in concert to provide all the needed information to the enterprise facility's 102 network and/or client facility 144 for control of application execution. In an embodiment, the policy update module and security update module may be combined into a single update module.

As threats are identified and characterized, the threat management facility 100 may create definition updates that may be used to allow the threat management facility 100 to detect and remediate the latest malicious software, unwanted applications, configuration and policy changes, and the like. The threat definition facility 114 may contain threat identification updates, also referred to as definition files. A definition file may be a virus identity file that may include definitions of known or potential malicious code. The definition files may provide information that may identify malicious code within files, applications, or the like. The definition files may be accessed by security management facility 122 when scanning files or applications within the client facility 144 for the determination of malicious code that may be within the file or application. The definition files may contain a number of commands, definitions, or instructions, to be parsed and acted upon, or the like. In embodiments, the client facility 144 may be updated with new definition files periodically to provide the client facility 144 with the most recent malicious code definitions; the updating may be performed on a set time period, may be updated on demand from the client facility 144, may be updated on demand from the network, may be updated on a received malicious code alert, or the like. In an embodiment, the client facility 144 may request an update to the definition files from an update facility 120 within the network, may request updated definition files from a computing facility external to the network, updated definition files may be provided to the client facility 114 from within the network, definition files may be provided to the client facility 144 from an external computing facility from an external network, or the like.

In an embodiment, a definition management facility 114 may provide for the timely updates of definition files information to the network, client facilities 144, and the like. New and altered malicious code and malicious applications may be continually created and distributed to networks worldwide. The definition files that maintain the definitions of the malicious code and malicious application information for the protection of the networks and client facilities 144 may need continual updating to provide continual defense of the network and client facility 144 from the malicious code and malicious applications. The definition files management may provide for automatic and manual methods of updating the definition files. In embodiments, the network may receive definition files and distribute the definition files to the network client facilities 144, the client facilities 144 may receive the definition files directly, or the network and client facilities 144 may both receive the definition files, or the like. In an embodiment, the definition files may be updated on a fixed periodic basis, on demand by the network and/or the client facility 144, as a result of an alert of a new malicious code or malicious application, or the like. In an embodiment, the definition files may be released as a supplemental file to an existing definition files to provide for rapid updating of the definition files.

In a similar manner, the security management facility 122 may be used to scan an outgoing file and verify that the outgoing file is permitted to be transmitted per the enterprise facility 102 rules and policies. By checking outgoing files, the security management facility 122 may be able discover malicious code infected files that were not detected as incoming files as a result of the client facility 144 having been updated with either new definition files or policy management facility 112 information. The definition files may discover the malicious code infected file by having received updates of developing malicious code from the administration facility 134, updates from a definition files provider, or the like. The policy management facility 112 may discover the malicious code infected file by having received new updates from the administration facility 134, from a rules provider, or the like.

The threat management facility 100 may provide for a way to control access to the enterprise facility 102 networks. For instance, the enterprise facility 102 may want to restrict access to certain applications, networks, files, printers, servers, databases, or the like. In addition, the enterprise facility 102 may want to restrict user access under certain conditions, such as the user's location, usage history, need to know, job position, connection type, time of day, method of authentication, client-system configuration, or the like. Network access rules may be developed by the enterprise facility 102, or pre-packaged by a supplier, and managed by the threat management facility 100 in conjunction with the administration facility 134. Network access rules and control may be responsible for determining if a client facility 144 application should be granted access to a requested network location. The network location may be on the same network as the facility or may be on another network. In an embodiment, the network access control may verify access rights for client facilities 144 from within the network or may verify access rights of computer facilities from external networks. When network access for a client facility 144 is denied, the network access control may send an information file to the client facility 144, the information file may contain data or commands that may provide instructions for the remedial action facility 128. The information sent by the network access facility 124 control may be a data file. The data file may contain a number of commands, definitions, instructions, or commands to be parsed and acted upon through the remedial action facility 128, or the like. The information sent by the network access facility 124 control may be a command or command file that the remedial action facility 128 may access and take action upon.

In an embodiment, the network access rules 124 may provide an information store to be accessed by the network access control. The network access rules facility 124 may include databases such as a block list, a black list, an allowed list, a white list, an unacceptable network site database, an acceptable network site database, a network site reputation database, or the like of network access locations that may or may not be accessed by the client facility 144. Additionally, the network access rules facility 124 may incorporate rule evaluation; the rule evaluation may parse network access requests and apply the parsed information to network access rules. The network access rule facility 124 may have a generic set of rules that may be in support of an enterprise facility's 102 network access policies, such as denying access to certain types of websites 158, controlling instant messenger 162 accesses, or the like. Rule evaluation may include regular expression rule evaluation, or other rule evaluation method for interpreting the network access request and comparing the interpretation to the established rules for network access. In an embodiment, the network access rules facility 124 may receive a rules evaluation request from the network access control and may return the rules evaluation to the network access control.

Similar to the threat definitions facility 114, the network access rule facility 124 may provide updated rules and policies to the network access rules facility 124. The network access rules facility 124 may be maintained by the network administration facility 134 using the network access rules facility 124 management. In an embodiment, the network administration facility 134 may be able to maintain a set of access rules manually by adding rules, changing rules, deleting rules, or the like. Additionally, the administration facility 134 may be able to retrieve predefined rule sets from a provider that may provide a set of rules to be applied to an entire enterprise facility 102. The network administration facility 134 may be able to modify the predefined rules as needed for a particular enterprise facility 102 using the network access rules facility 124 management.

When a threat or policy violation is detected by the threat management facility 100, the threat management facility 100 may provide for a remedial action facility 128. Remedial action may take a plurality of forms, such as terminating or modifying an ongoing process or interaction, sending a warning to a client or administration facility 134 of an ongoing process or interaction, executing a program or application to remediate against a threat or violation, record interactions for subsequent evaluation, or the like. Remedial action may be associated with an application that responds to information that a client facility 144 network access request has been denied. In an embodiment, when the data file is received, remedial action may parse the data file, interpret the various aspects of the data file, and act on the parsed data file information to determine actions to be taken on an application requesting access to a denied network location. In an embodiment, when the data file is received, remedial action may access the threat definitions to parse the data file and determine an action to be taken on an application requesting access to a denied network location. In an embodiment, the information received from the facility may be a command or a command file. The remedial action facility may carry out any commands that are received or parsed from a data file from the facility without performing any interpretation of the commands. In an embodiment, the remedial action facility may interact with the received information and may perform various actions on a client requesting access to a denied network location. The action may be one or more of continuing to block all requests to a denied network location, a malicious code scan on the application, a malicious code scan on the client facility 144, quarantine of the application, terminating the application, isolation of the application, isolation of the client facility 144 to a location within the network that restricts network access, blocking a network access port from a client facility 144, reporting the application to a administration facility 134, or the like.

Remedial action may be provided as a result of a detection of a threat or violation. The detection techniques facility 130 may include monitoring the enterprise facility 102 network or end-point devices, such as by monitoring streaming data through the gateway, across the network, through routers and hubs, and the like. The detection techniques facility 130 may include monitoring activity and stored files on computing facilities, such as on server facilities 142, desktop computers, laptop computers, other mobile computing devices, and the like. Detection techniques, such as scanning a computer's stored files, may provide the capability of checking files for stored threats, either in the active or passive state. Detection techniques, such as streaming file management, may provide the capability of checking files received at the network, gateway facility, client facility 144, and the like. This may provide the capability of not allowing a streaming file or portions of the streaming file containing malicious code from entering the client facility 144, gateway facility, or network. In an embodiment, the streaming file may be broken into blocks of information, and a plurality of virus identities may be used to check each of the blocks of information for malicious code. In an embodiment, any blocks that are not determined to be clear of malicious code may not be delivered to the client facility 144, gateway facility, or network.

Verifying that the threat management facility 100 is detecting threats and violations to established policy, may require the ability to test the system, either at the system level or for a particular computing component. The testing facility 118 may allow the administration facility 134 to coordinate the testing of the security configurations of client facility 144 computing facilities on a network. The administration facility 134 may be able to send test files to a set of client facility 144 computing facilities to test the ability of the client facility 144 to determine acceptability of the test file. After the test file has been transmitted, a recording facility may record the actions taken by the client facility 144 in reaction to the test file. The recording facility may aggregate the testing information from the client facility 144 and report the testing information to the administration facility 134. The administration facility 134 may be able to determine the level of preparedness of the client facility 144 computing facilities by the reported information. Remedial action may be taken for any of the client facility 144 computing facilities as determined by the administration facility 134; remedial action may be taken by the administration facility 134 or by the user of the client facility 144.

The threat research facility 132 may provide a continuously ongoing effort to maintain the threat protection capabilities of the threat management facility 100 in light of continuous generation of new or evolved forms of malware. Threat research may include researchers and analysts working on known and emerging malware, such as viruses, rootkits a spyware, as well as other computer threats such as phishing, spam, scams, and the like. In embodiments, through threat research, the threat management facility 100 may be able to provide swift, global responses to the latest threats.

The threat management facility 100 may provide threat protection to the enterprise facility 102, where the enterprise facility 102 may include a plurality of networked components, such as client facility 144, server facility 142, DNS server facility 210, administration facility 134, firewall 138, gateway, hubs 148, routers, threat management appliance 140, desktop users, mobile users, and the like. In embodiments, it may be the end-point computer security facility 152, located on a computer's desktop, which may provide threat protection to a user, and associated enterprise facility 102. The end-point computer security facility 152 may be an application loaded onto the computer platform or computer support component, where the application may accommodate the plurality of computer platforms and/or functional requirements of the component. For instance, a client facility 144 computer may be one of a plurality of computer platforms, such as Windows, Macintosh, Linux, and the like, where the end-point computer security facility 152 may be adapted to the specific platform, while maintaining a uniform product and product services across platforms. Additionally, components may have different functions to serve within the enterprise facility's 102 networked computer-based infrastructure. For instance, computer support components provided as hubs 148, routers, server facility 142, DNS server facility 210, firewalls 138, and the like, may require unique security application software to protect their portion of the system infrastructure, while providing an element in an integrated threat management system that extends out beyond the threat management facility 100 to incorporate all computer resources under its protection.

The enterprise facility 102 may include a plurality of client facility 144 computing platforms on which the end-point computer security facility 152 is adapted. A client facility 144 computing platform may be a computer system that is able to access a service on another computer, such as a server facility 142, via a network. This client facility 144 server facility 142 model may apply to a plurality of networked applications, such as a client facility 144 connecting to an enterprise facility 102 application server facility 142, a web browser client facility 144 connecting to a web server facility 142, an e-mail client facility 144 retrieving e-mail from an internet 154 service provider's mail storage servers 142, and the like. In embodiments, traditional large client facility 144 applications may be switched to websites, which may increase the browser's role as a client facility 144. Clients 144 may be classified as a function of the extent to which they perform their own processing. For instance, client facilities 144 are sometimes classified as a fat client facility 144 or thin client facility 144. The fat client facility 144, also known as a thick client facility 144 or rich client facility 144, may be a client facility 144 that performs the bulk of data processing operations itself, and does not necessarily rely on the server facility 142. The fat client facility 144 may be most common in the form of a personal computer, where the personal computer may operate independent of any server facility 142. Programming environments for fat clients 144 may include Curl, Delphi, Droplets, Java, win32, X11, and the like. Thin clients 144 may offer minimal processing capabilities, for instance, the thin client facility 144 may primarily provide a graphical user interface provided by an application server facility 142, which may perform the bulk of any required data processing. Programming environments for thin clients 144 may include JavaScript/AJAX, ASP, JSP, Ruby on Rails, Python's Django, PHP, and the like. The client facility 144 may also be a mix of the two, such as processing data locally, but relying on a server facility 142 for data storage. As a result, this hybrid client facility 144 may provide benefits from both the fat client facility 144 type, such as multimedia support and high performance, and the thin client facility 144 type, such as high manageability and flexibility. In embodiments, the threat management facility 100, and associated end-point computer security facility 152, may provide seamless threat protection to the plurality of clients 144, and client facility 144 types, across the enterprise facility 102.

The enterprise facility 102 may include a plurality of server facility 142, such as application servers 142, communications servers 142, file servers 142, database servers 142, proxy servers 142, mail servers 142, fax servers 142, game servers 142, web servers 142, and the like. A server facility 142, which may also be referred to as a server facility 142 application, server facility 142 operating system, server facility 142 computer, or the like, may be an application program or operating system that accepts client facility 144 connections in order to service requests from clients 144. The server facility 142 application may run on the same computer as the client facility 144 using it, or the server facility 142 and the client facility 144 may be running on different computers and communicating across the network. Server facility 142 applications may be divided among server facility 142 computers, with the dividing depending upon the workload. For instance, under light load conditions all server facility 142 applications may run on a single computer and under heavy load conditions a single server facility 142 application may run on multiple computers. In embodiments, the threat management facility 100 may provide threat protection to server facilities 142 within the enterprise facility 102 as load conditions and application changes are made.

A server facility 142 may also be an appliance facility 140, where the appliance facility 140 provides specific services onto the network. Though the appliance facility 140 is a server facility 142 computer, that may be loaded with a server facility 142 operating system and server facility 142 application, the enterprise facility 102 user may not need to configure it, as the configuration may have been performed by a third party. In an embodiment, an enterprise facility 102 appliance may be a server facility 142 appliance that has been configured and adapted for use with the threat management facility 100, and located within the facilities of the enterprise facility 102. The enterprise facility's 102 threat management appliance may enable the enterprise facility 102 to administer an on-site local managed threat protection configuration, where the administration facility 134 may access the threat resources through an interface, such as a web portal. In an alternate embodiment, the enterprise facility 102 may be managed remotely from a third party, vendor, or the like, without an appliance facility 140 located within the enterprise facility 102. In this instance, the appliance functionality may be a shared hardware product between pluralities of enterprises 102. In embodiments, the appliance facility 140 may be located at the enterprise facility 102, where the enterprise facility 102 maintains a degree of control. In embodiments, a hosted service may be provided, where the appliance 140 may still be an on-site black box to the enterprise facility 102, physically placed there because of infrastructure requirements, but managed by a third party, vendor, or the like.

Simple server facility 142 appliances may also be utilized across the enterprise facility's 102 network infrastructure, such as switches, routers, wireless routers, hubs 148, gateways, print servers 142, net modems, and the like. These simple server facility appliances may not require configuration by the enterprise facility 102, but may require protection from threats via an end-point computer security facility 152. These appliances may provide interconnection services within the enterprise facility 102 network, and therefore may advance the spread of a threat if not properly protected.

One way for a client facility 144 to be protected from threats from within the enterprise facility 102 network may be a personal firewall. A personal firewall may be an application that controls network traffic to and from a client, permitting or denying communications based on a security policy. Personal firewalls may be designed for use by end-users, which may result in protection for only the computer on which it's installed. Personal firewalls may be able to control network traffic by providing prompts each time a connection is attempted and adapting security policy accordingly. Personal firewalls may also provide some level of intrusion detection, which may allow the software to terminate or block connectivity where it suspects an intrusion is being attempted. Other features that may be provided by a personal firewall may include alerts about outgoing connection attempts, control of program access to networks, hiding the client from port scans by not responding to unsolicited network traffic, monitoring of applications that may be listening for incoming connections, monitoring and regulation of incoming and outgoing network traffic, prevention of unwanted network traffic from installed applications, reporting applications that make connection attempts, reporting destination servers with which applications may be attempting communications, and the like. In embodiments, the personal firewall may be provided by the treat management facility 100.

Another important component that may be protected by an end-point computer security facility 152 is a network firewall facility 138, which may be a hardware or software device that may be configured to permit, deny, or proxy data through a computer network that has different levels of trust in its source of data. For instance, an internal enterprise facility 102 network may have a high level of trust, because the source of all data has been sourced from within the enterprise facility 102. An example of a low level of trust is the Internet 154, because the source of data may be unknown. A zone with an intermediate trust level, situated between the Internet 154 and a trusted internal network, may be referred to as a “perimeter network”. Since firewall facilities 138 represent boundaries between threat levels, the end-point computer security facility 152 associated with the firewall facility 138 may provide resources that may control the flow of threats at this enterprise facility 102 network entry point. Firewall facilities 138, and associated end-point computer security facility 152, may also be associated with a network node that may be equipped for interfacing between networks that use different protocols. In embodiments, the end-point computer security facility 152 may provide threat protection in a plurality of network infrastructure locations, such as at the enterprise facility 102 network entry point, i.e. the firewall facility 138 or gateway; at the server facility 142; at distribution points within the network, i.e. the routers and hubs 148; at the desktop of client facility 144 computers; and the like. In embodiments, the most effective location for threat detection may be at the user's computer desktop end-point computer security facility 152.

The interface between the threat management facility 100 and the enterprise facility 102, and through the appliance facility 140 to embedded end-point computer security facilities, may include a set of tools that may be the same for all enterprise implementations, but allow each enterprise to implement different controls. In embodiments, these controls may include both automatic actions and managed actions. Automatic actions may include downloads of the end-point computer security facility 152 to components of the enterprise facility 102, downloads of updates to existing end-point computer security facilities of the enterprise facility 102, uploaded network interaction requests from enterprise facility 102 components to the threat management facility 100, and the like. In embodiments, automatic interactions between the enterprise facility 102 and the threat management facility 100 may be configured by the threat management facility 100 and an administration facility 134 in the enterprise facility 102. The administration facility 134 may configure policy rules that determine interactions, such as developing rules for accessing applications, as in who is authorized and when applications may be used; establishing rules for ethical behavior and activities; rules governing the use of entertainment software such as games, or personal use software such as IM 162 and VoIP 164; rules for determining access to enterprise facility 102 computing resources, including authentication, levels of access, risk assessment, and usage history tracking; rules for when an action is not allowed, such as whether an action is completely denied or just modified in its execution; and the like. The administration facility 134 may also establish license management, which in turn may further determine interactions associated with a licensed application. In embodiments, interactions between the threat management facility 100 and the enterprise facility 102 may provide threat protection to the enterprise facility 102 by managing the flow of network data into and out of the enterprise facility 102 through automatic actions that may be configured by the threat management facility 100 or the administration facility 134.

Client facilities 144 within the enterprise facility 102 may be connected to the enterprise facility 102 network by way of wired network facilities 148 or wireless network facilities 150. Client facilities 144 connected to the enterprise facility 102 network via a wired facility 148 or wireless facility 150 may receive similar protection, as both connection types are ultimately connected to the same enterprise facility 102 network, with the same end-point computer security facility 152, and the same threat protected enterprise facility 102 environment. Mobile wireless facility 150 clients 144, because of their ability to connect to any wireless 150 network access point, may connect to the internet 154 outside the enterprise facility 102, and therefore outside the threat-protected environment of the enterprise facility 102. In this instance the mobile client facility 144, if not for the presence of the end-point computer security facility 152 may experience a malware attack or perform actions counter to enterprise facility 102 established policies. In addition, there may be a plurality of ways for the threat management facility 100 to protect the out-of-enterprise facility 102 mobile client facility 144 that has an embedded end-point computer security facility 152, such as by providing URI filtering in personal routers, using a web appliance as a DNS proxy, or the like. Mobile client facilities 144 that are components of the enterprise facility 102 but temporarily outside connectivity with the enterprise facility 102 network, may be provided with the same threat protection and policy control as client facilities 144 inside the enterprise facility 102. In addition, mobile client facilities 144 may receive the same interactions to and from the threat management facility 100 as client facilities 144 inside the enterprise facility 102, where mobile client facilities 144 may be considered a virtual extension of the enterprise facility 102, receiving all the same services via their embedded end-point computer security facility 152.

Interactions between the threat management facility 100 and the components of the enterprise facility 102, including mobile client facility 144 extensions of the enterprise facility 102, may ultimately be connected through the internet 154. Threat management facility 100 downloads and upgrades to the enterprise facility 102 may be passed from the firewalled networks of the threat management facility 100 through to the end-point computer security facility 152 equipped components of the enterprise facility 102. In turn the end-point computer security facility 152 components of the enterprise facility 102 may upload policy and access requests back across the internet 154 and through to the threat management facility 100. The Internet 154 however, is also the path through which threats may be transmitted from their source. These network threats may include threats from a plurality of sources, including websites 158, e-mail 160, IM 162, VoIP 164, application software, and the like. These threats may attempt to attack a mobile enterprise facility 102 client facility 144 equipped with an end-point computer security facility 152, but in embodiments, as long as the mobile client facility 144 is embedded with an end-point computer security facility 152, as described above, threats may have no better success than if the mobile client facility 144 where inside the enterprise facility 102.

However, if the mobile client facility 144 where to attempt to connect into an unprotected connection point, such as at a secondary location 108 that is not a part of the enterprise facility 102, the mobile client facility 144 may be required to request network interactions through the threat management facility 100, where contacting the threat management facility 100 may be performed prior to any other network action. In embodiments, the client facility's 144 end-point computer security facility 152 may manage actions in unprotected network environments such as when the client facility 144 is in a secondary location 108 or connecting wirelessly 150 to a non-enterprise facility 102 wireless internet 154 connection, where the end-point computer security facility 152 may dictate what actions are allowed, blocked, modified, or the like. For instance, if the client facility's 144 end-point computer security facility 152 is unable to establish a secured connection to the threat management facility 100, the end-point computer security facility 152 may inform the user of such, and recommend that the connection not be made. In the instance when the user chooses to connect despite the recommendation, the end-point computer security facility 152 may perform specific actions during or after the unprotected connection is made, including running scans during the connection period, running scans after the connection is terminated, storing interactions for subsequent threat and policy evaluation, contacting the threat management facility 100 upon first instance of a secured connection for further actions and or scanning restricting access to network and local resources, or the like. In embodiments, the end-point computer security facility 152 may perform specific actions to remediate possible threat incursions or policy violations during or after the unprotected connection.

The secondary location 108 may have no end-point computer security facilities 152 as a part of its computer components, such as its firewalls 138, servers 142, clients 144, hubs 148, wireless hubs 150, and the like. As a result, the computer components of the secondary location 108 may be open to threat attacks, and become potential sources of threats, as well as any mobile enterprise facility 102 clients 144 that may be connected to the secondary location's 108 network. In this instance, these computer components may now unknowingly spread a threat to other components connected to the network.

Some threats may not come directly from the Internet 154, such as from non-enterprise facility 102 controlled mobile devices that are physically brought into the enterprise facility 102 and connected to the enterprise facility 102 client facilities 144. The connection may be made from direct connection with the enterprise facility's 102 client facility 144, such as through a USB port, or in physical proximity with the enterprise facility's 102 client facility 144 such that a wireless facility 150 connection can be established, such as through a Bluetooth connection. These physical proximity threats 110 may be another mobile computing device, a portable memory storage device, a mobile communications device, or the like, such as CDs and DVDs 170, memory stick 174, flash drive 174, external hard drive, cell phone 178, PDAs 180, MP3 players, digital cameras, point-to-point devices, digital picture frames, digital pens, navigation devices, appliances, and the like. A physical proximity threat 110 may have been previously infiltrated by network threats while connected to an unprotected network connection outside the enterprise facility 102, and when connected to the enterprise facility 102 client facility 144, pose a threat. Because of their mobile nature, physical proximity threats 110 may infiltrate computing resources in any location, such as being physically brought into the enterprise facility 102 site, connected to an enterprise facility 102 client facility 144 while that client facility 144 is mobile, plugged into an unprotected client facility 144 at a secondary location 108, and the like. A mobile device, once connected to an unprotected computer resource, may become a physical proximity threat 110. In embodiments, the end-point computer security facility 152 may provide enterprise facility 102 computing resources with threat protection against physical proximity threats 110, for instance, through scanning the device prior to allowing data transfers, through security validation certificates, through establishing a safe zone within the enterprise facility 102 computing resource to transfer data into for evaluation, and the like.

Now that the overall system has been described, we turn towards a set of embodiments where data is scanned in a streaming environment. It should be understood that the following embodiments may be managed through a threat management facility 100 along with other services, such as those described herein.

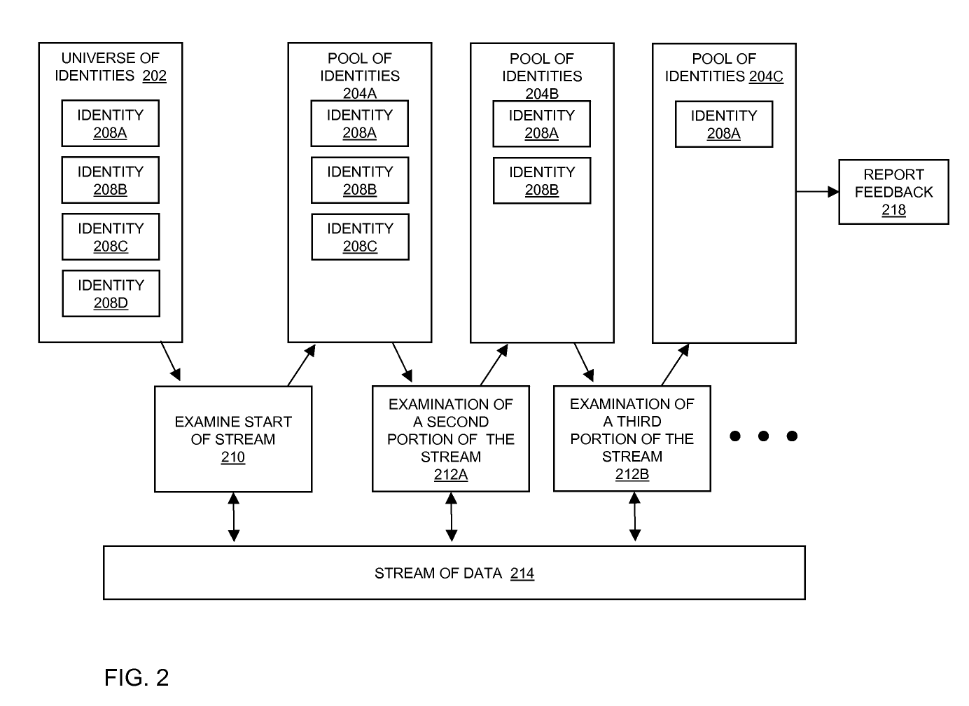

Referring to FIG. 2, in embodiments, data may be scanned as it is streamed through a computing facility. The data may be intercepted and scanned in portions as it flows through the computing facility. The scanning process may perform an evaluation of the data through the use of a pool of identities. The pool of identities 204 may be selected from a universe of identities 202 (i.e. a subset of identities may be selected from a larger set) to limit the number of identities to be used in the scan. The pool of identities 204 may be selected based on an examination of a portion of the data stream 210. By intelligently limiting the number of identities used in the scan, the scan can be shortened and this can lead to a significant increase in the computing performance and/or bandwidth. An initial target set of identities may be used in the initial evaluation to select the pool of identities 204 that will be used in the on-going scan. Further, methods and systems according to the present invention may change the contents of the pool of identities 204A-C as examination 212A-B of the data stream 214 progresses. For example, an action may be taken in association with the pool of identities 204, identities 208 may be removed as they provide a “not matched” result, identities 208 may be removed as they provide a “matched” result, identities 208 may be retained as they provide a “more information required result”, identities 208 may be retained as they provide an uncertain result, identities 208 may be added as identities 208 identify a need for additional identities 208, identities 208 may be subtracted as the identities 208 identify a need to remove identities 208, and the like. In addition, results from identity actions may be provided as feedback 218, such as match found, no match found, ‘x’ number of matches found, a list of identities finding matches, and the like. In embodiments, the present invention may provide for more time effective scanning of streaming data 214 due to the initial selection of the pool of identities 204A and the subsequent changes to the pool of identities 204A-C.

In embodiments, certain content flowing through the data stream may be targeted or looked for. The target content may be associated with the identification of unwanted content, malware, spam, unwanted applications, private data leakage, restricted material, confidential materials, illegal materials, controlled materials, illegal exchange of copyrighted materials, illegal exchange of music files, and the like.

In embodiments, a scanning engine uses identities 208 to identify target data within the data stream such that target content can be identified. Identities themselves come in many forms and the present invention is not limited to any one identity form. In embodiments, an identity 208 may be a pattern of data, data string, or other data arrangement that can be ‘matched’ with data in the data stream being scanned. Matching data from the data stream may involve matching strings contained in the data stream, matching bytes, matching sub-bytes, matching multiple bytes, or other portions of the data stream In other embodiments the identities 208 are byte code or other form of executable code that can perform process steps on data portions extracted from the data stream being analyzed. In embodiments, identities 208 may be associated with executable instructions for establishing the presence of the target content, such as with executable software, executable byte code, and the like, where the executable code may be running in association with the data scan engine. In embodiments, the data scan engine may be a virtual machine and the identity 208 may be byte code executing on the virtual machine. Further, identities 208 may provide directions or actions to the ongoing scan activity, such as to add or subtract identities 208 from the pool of identities 204, skip ahead in the scan sequence, repeat some portion of the scan, store information temporarily, and the like.

In embodiments, the universe of identities 202 may be all identities 208 available for the scanning of streaming data 214, scanning of malware, scanning of unwanted data, identification of applications, all identities 208 available for a given target content, and the like. In embodiments, the universe of identities 202 may be the source of identities for the initial creation of the pool of identities 204A, the source of identities 204 for the subsequent addition of identities 204 to the pool of identities 204, and the like. In embodiments, the universe of identities 202 may be modified, added to, subtracted from, and the like, as a result of threat research 132 within the threat management facility 100.

In embodiments, the pool of identities 204 may be initially selected from the universe of identities 202. The pool of identities 204 may subsequently be modified based on the examination 210, 212 of the contents of the streaming data 214 as it becomes available, such as through the selection, addition, or removal of identities 208 to and from the pool of identities 204. The pool of identities 204 may be based on a portion of the data stream 214 being indicative of a type of content, a group of identities, a type of application, a type of text file, a class of media, and the like. In embodiments, the pool of identities 204 may be created and maintained for a given streaming data scan to correspond to target content, where the target content may be identified through the scanning process. In embodiments, the contents of the pool of identities 204 may be maintained at a minimum required number of identities 208 in order to execute scanning in a timely manner.

In embodiments, as the identity functions are performed, an outcome status for each identity may be determined such as “matched’, “not matched”, “requires more data”, and the like. In embodiments, if the identity outcome is “matched” it may indicate that the identity 208 has detected the target content within the streaming file 214. If the identity outcome is “not matched” it may indicate that the identity 208 has not detected any target content within the streaming file 214. If the identity outcome is “requires more data” it may indicate that the identity 208 needs to examine additional portions of the data stream 214 in order to determine a match or no-match. In embodiments there may be other identity outcomes, such indeterminate, uncertain, probable, certain, and the like.

In embodiments, data may be analyzed as it becomes available (e.g. in a data stream) by an identity 208 being executed against the streaming data 214. In embodiments, all of the identities 208 in the identity pool may be executed against the streaming data 214 as the data becomes available. In other embodiments, a subset of identities 208 are executed against the streaming data 214 as the data becomes available. In embodiments, the streaming data 214 may be organized in blocks, where the block size may not be specified and may be defined as short as a single bit or byte, as long as the entire file, as a continuous streaming data files, and the like. In embodiments, the scanning of the data stream 214 may start when the first block of data becomes available. In embodiments, if more data is required and has not yet become available, the identity 208 may be put in a hold state and a next identity 208 may be carried out. In embodiments, the outcome of this type of hold operation may change outcome status from “match/no match” to “match/undecided/no match”. In embodiments, the identities 208 that have the “undecided” outcome status may be kept in the pool of identities 204, where the scanning engine may return to the identity 208 once more data becomes available.

In embodiments, the scanning of the streaming data 214 with identities 208 from the pool of identities 204 may continue until all of the identities 208 are resolved with a “match’ or “not matched”, until the end of the streaming data 214 is reached, until a single ‘match’ is identified, until a predetermined set of matches are identified, and the like. In embodiments, an identity 208 with an “undecided’ outcome may be resolved to a “matched” or “not matched’ outcome as all of the streaming data 214 becomes available. In embodiments, the scanning engine may continue to attempt to determine the outcome of the identities 208 until all the “undecided” outcomes have been resolved. In embodiments, if speed of analysis is important, and the knowledge of potential multiple identifications of target data is not required, the analysis may stop when the first “matched” outcome is reached.

In embodiments, the pool of identities may be reused as new data from the data stream is received. The pool of identities may change as the pool is used. For example, as described herein elsewhere, depending on the process being run, identities may be added or removed from the pool as scans on data portions are completed. In embodiments, the pool is reused until the pool of identities 204 is empty, until the end of the pool of identities 204 is reached, until there is an indication from one of the identities 208 to stop, and the like. In embodiments, there may be a difference between “pool empty” and “end of pool”. The process being run may be completed if the pool of identities 204 ends up containing a certain list of identities 208. In embodiments, an empty pool may mean that there are no identities 208 remaining in the pool, no identities 208 from the initial list remain in the pool, and the like. In embodiments, an end of pool result may mean the end of the list may have been reached and a return to the beginning of the list is required. In another embodiment, if the end of pool is reached, a test may be performed to determine if the end of the data stream 214 has been reached to indicate if the scanning loop should be continued. In embodiments, this process may continue until all of the outcome statuses are set to a resolved status such as “matched”, “not matched”, or the like.

In embodiments, the identities 208 within the pool of identities 204 might be ordered based on speed, importance, size, and the like, which may be used to optimize the performance of the scanning. In embodiments, the function of the identities 208 may not be limited to matching. For example, certain functions relate to the control the contents of the pool of identities 204. An identity 208 may be able to clear the pool of identities 204, delete all remaining identities 208 in the pool of identities, and the like.

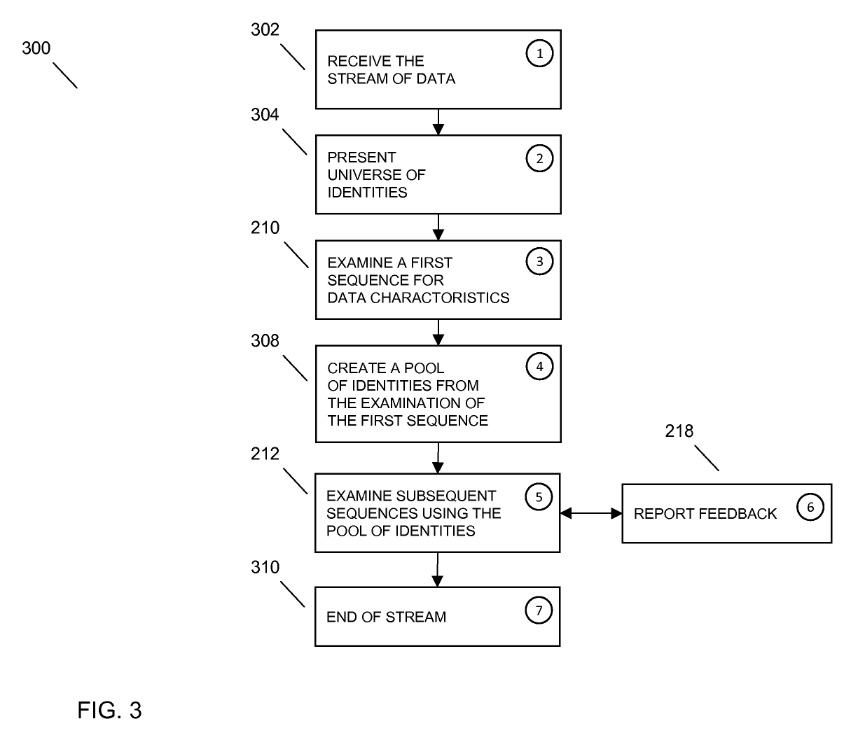

Referring to FIG. 3, an embodiment 300 of the present invention is provided. In the first step 302 of the process depicted, the data stream 214 is received, where the data stream 214 may be any ordered sequence of data, such as in the transmission or reception of a text file, a video file, an image file, an audio file, a multimedia file, an email, an attachment, an instant message, a text message, metadata, a download, a file transfer, a broadcast, a live feed, a streaming media file, and the like. In embodiments, the data stream 214 may be received from a source and transmitted to a destination without being stored. In embodiments, data associated with the data stream may be temporarily stored, such as source information, destination information, location information, headers, checksums, identifiers, structural information, hash values, and the like. In embodiments, the data stream 214 may be provided as a plurality of data streams 214, where the searching is performed on at least one of the plurality of data streams 214.

In embodiments, a second step 304 of the process is depicted, where the universe of identities 202 is presented that may be used to identify the target content of the data stream 214, such as content associated with a string of data, a sequence of data, a pattern of data, added data, missing data, inserted data, changed data, a block of data, a data file, a data type, and the like. In embodiments, the identities 208 may be a set of rules, procedures, instructions, sequences, and the like, that look for content in the data stream 214, and may be implemented in software, such as in a program, a routine, a subroutine, a sequence of code, and the like.

In embodiments, a third step 210 of the process is depicted, where a first sequence of the data stream may be examined. In embodiments, the first sequence of the steaming data may be a plurality of bits, a plurality of bytes, a plurality of words, a block of data, a sequence of data, a header, a checksum, a preamble, and the like.

In embodiments, a forth step 308 of the process is depicted, where the pool of identities 204 is created from the universe of identities 202, based on the examination of the first sequence 210 of the data stream 214. In embodiments, the examination of the first sequence 210 of data stream 214 may reveal a characteristic associated with the target content, such as the characteristic of a text file, a word processor file, a spreadsheet file, a drawing file, an image file, a video file, a music file, an email, a text message, an http file, an ftp transfer, and the like, where the characteristic may lead to a selection of a group of identities 208 from the universe of identities 202 to be included in the pool of identities 204.

In embodiments, a fifth step 212 of the process is depicted, where subsequent sequences of the data stream 214 may be examined 212, and where the subsequent sequences of the data stream 214 may be evaluated by the identities 208 in the pool of identities 204 to identify target content within the data stream 214. In embodiments, the identities 208 in the pool of identities 204 may determine that target content has been found or not found, produce indeterminate results, require other sequences of the data stream 214 to determine whether target content is found, and the like. In embodiments, the identity 208 that determines that content has been found or not found may be removed from the pool of identities 204, and the identity 208 that produces indeterminate results or requires other sequences of the data stream 214 to evaluate, may be left in the pool of identities 204, placed in an alternate pool of identities 204, held in the pool of identities 204 for a later time, stored in an alternate location for a later time, and the like. In embodiments, the pool of identities 204 may be reset to include at least one identity 208 from the original pool of identities 204 for the examination 212 of a next subsequent sequence of the data stream 214.

In embodiments, a sixth step 218 of the process is depicted, where report feedback 218 may be provided, where the report may be provided to a reporting facility. In embodiments, reports may be provided when the data stream comes to an end, until at least one occurrence of the target content has been found, until all occurrences of the target content have been found, and the like. In embodiments, the last step in the process may be the end of the data stream 310.

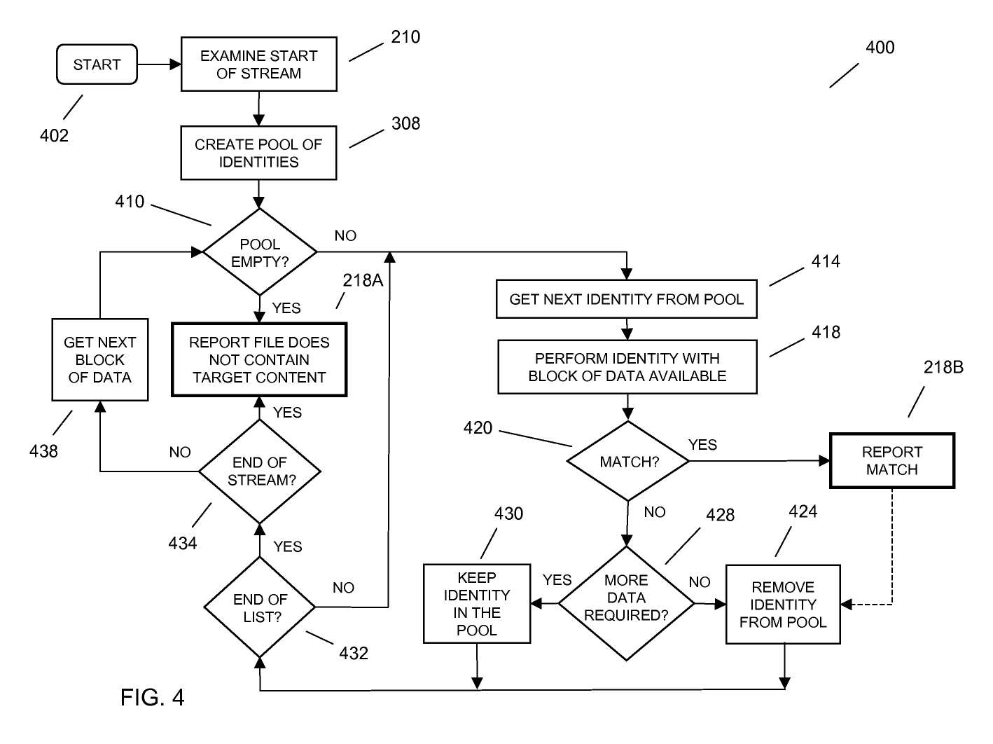

Referring to FIG. 4, an embodiment 400 of a process flow of the present invention is depicted in association with the embodiment 300 of the invention provided in FIG. 3, where in this instance identities 208 may be removed from the pool of identities 204 when a match is found by an examining identity 208. This example is only meant to be illustrative, and not to be limiting in any way. Those skilled in the art will recognize that alternate sequences, with added, removed, reordered functional blocks, will also satisfy the intention of the invention. In this example, the start of the data stream 214 is first examined 210 in order to provide information for the creation of identities 308 to be included in the pool of identities 202. Since at this first examination the pool is full 410, a first identity is selected 414 from the pool and executed 418 on the data available. If a match 420 is found, then a match feedback report 218B is generated and sent to the threat management facility 100, and the identity making the match is removed from the pool 424. In embodiments, the process may stop after a match has been reported 218B, such as when the first match is found, when a predetermined number of matches has been found, and the like. If however the identity does not find a match 420, it may indicate that more information is required 428. If more information is not required, than the identity may be removed 424. If more information is required 428, than the identity may be kept 430 in the pool of identities 430 for subsequent use. This process may repeat until the end of the list 432 of identities 208 in the pool of identities 202 is reached, and then may proceed still further until the end of the data stream 434 is reached. If the end of the stream is reached without a match 420 being found and reported 218B, than the data stream may be identified and reported 218A as not containing the target content being scanned for, and the process is complete. In embodiments, the process may continue 438 for a plurality of blocks of data, continuing until the stream is ended.

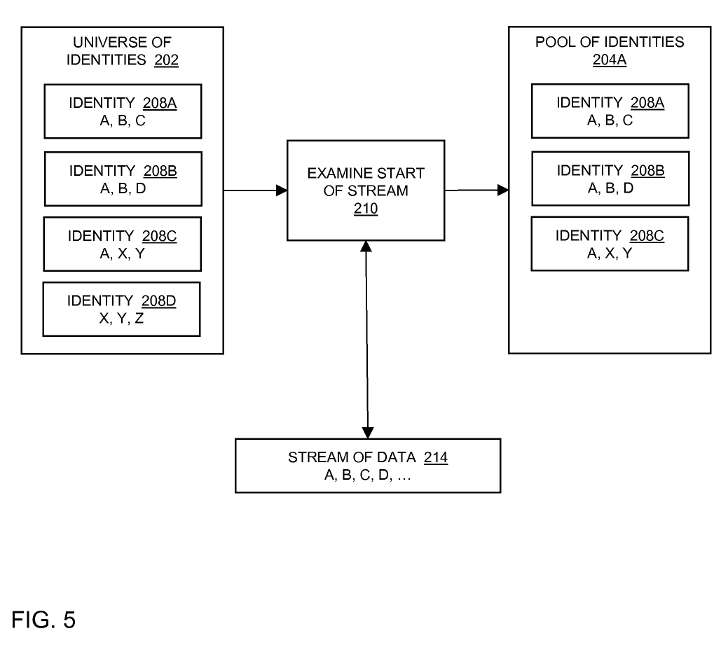

Referring to FIG. 5, an example of an embodiment of the present invention is provided in association with the embodiments 300,400, presented herein, where an initial universe of identities is provided for the examination of a stream of data. In this example the universe of identities 202 consists of four identities 208A-D. For the purposes of this example the identities are depicted as character matching sequences, where identity 208A is looking to match a character sequence ‘A’, ‘B’, ‘C’, the identity 208B is looking to match a character sequence ‘A’, ‘B’, ‘D’, the identity 208C is looking to match a character sequence ‘A’, ‘X’, ‘Y’, and identity 208C is looking to match a character sequence ‘X’, ‘Y’, ‘Z’. As the data stream 214 is received, the start of the stream of data is examined 210 for initial selection of the pool of identities 204A. In this case, the first character of the data stream is found to be an ‘A’, and since this matches the first character in identities 208A, 208B, and 208C of the universe of identities 202, it is these identities 208A-C that are selected to be included in the pool of identities 204.

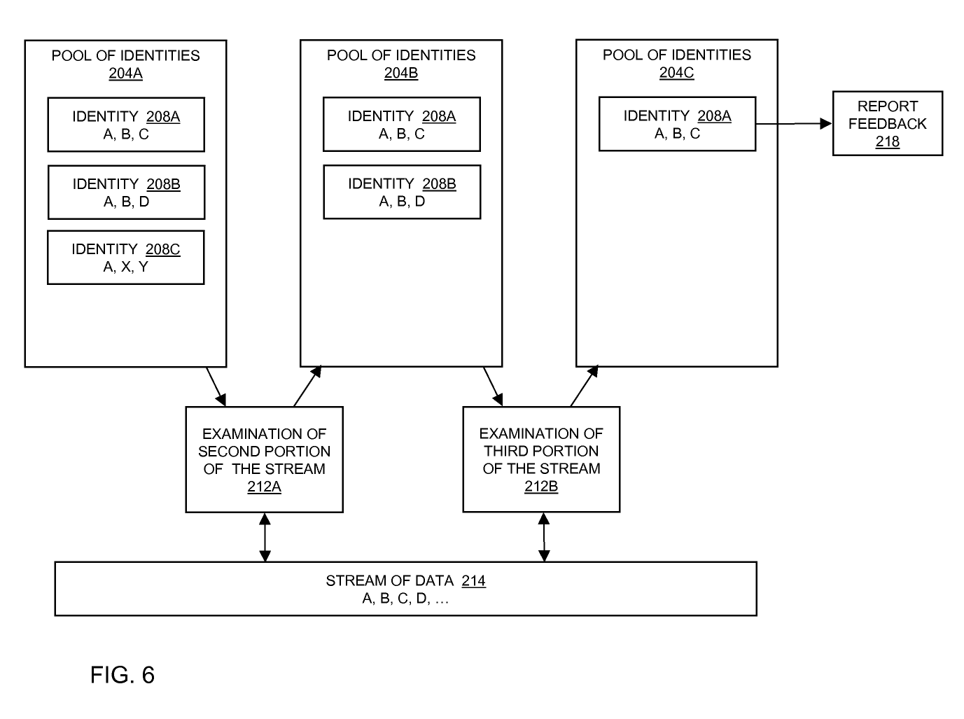

Continuing with the example started in FIG. 5, FIG. 6 depicts an embodiment of the inventive process where identities in the pool of identities may be removed based on examination of the stream of data. Here the data stream is further examined in an attempt to find a match in the data stream to one of the identities in the pool of identities. The second portion of the stream is then checked by all the identities in the pool of identities, where in this example the second portion is the second character ‘B’ in the stream. Identities 208A and 200B return an outcome where more data is required, while identity 208C is removed from the pool because the second examined portion of the data stream, a ‘B’, does not match the second character in its sequence, an ‘X’. The third portion of the stream is then checked by all the identities in the pool of identities, where in this example the third portion is the third character ‘C’ in the data stream, identity 208B is removed from the pool of identities for lack of a match to its third character in sequence. However, identity 208A matches the third character, and in addition, is at the end of the character sequence being sought. As a result, the entire sequence as defined in identity 208A is matched, and so a match report feedback is then generated. This example, as presented in association with FIGS. 5-6, is meant to be illustrative and not limiting in any way, such as in the number of identities involved, the functions performed by the identities, the number of examinations of the data stream, the results of the examinations, the actions taken as a result of the examinations, and the like, as described herein.

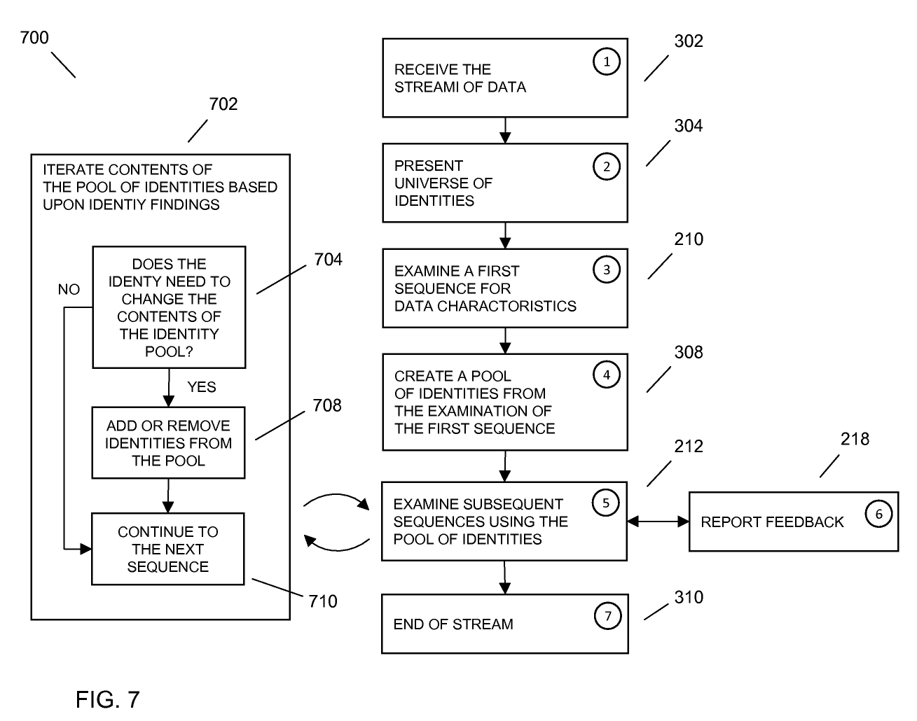

Referring to FIG. 7, an embodiment 700 is depicted in association with the embodiment 300 presented herein, where embodiment 700 provides an additional sequence of process steps 702 in an embodiment of the present invention. In embodiments, the additional sequence of process steps are in conjunction with the examination of subsequent sequences using the pool of identities 212. In this sequence of process steps 702, the contents of the pool of identities 204 is iterated based upon the findings of identities 208 during their examination 212 of the sequence, where the identity may decide whether it needs to change the contents of the pool of identities 704. The examination 212 may then continue to the next sequence 710 of the data stream 214, add identities to the pool of identities from the universe of identities 708, or subtract identities from the pool of identities 708. Further, the identity 208 itself may perform the iteration as a part of its programming, instruction, sequence, and the like. In embodiments, the iteration of the pool of identities 204 may be caused by the identity 208 revealing a characteristic associated with the target content, such as the characteristic of a text file, a word processor file, a spreadsheet file, a drawing file, an image file, a video file, a music file, an email, a text message, an http file, an ftp transfer, and the like. In embodiments, the finding of the characteristic may lead to a change in the identities 208 included in the pool of identities 204, the selection of a new pool of identities, and the like. This process of iterating the contents of the pool of identities 204 by the identities 208 themselves may continue through the examination 212 of the data stream 214, where the identities 208 included in the pool of identities 204 may constantly change in response to findings of the identities 208.

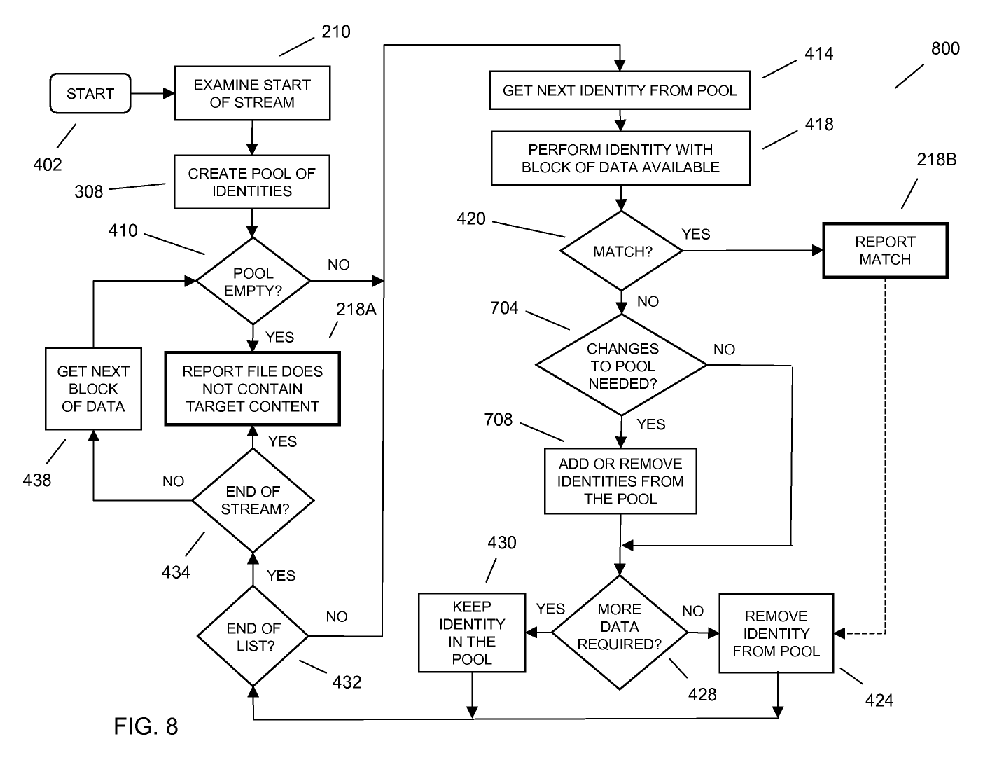

Referring to FIG. 8, an embodiment 800 of a process flow of the present invention is depicted in association with the embodiment 700 of the invention provided in FIG. 7, and additionally representing an extension of the embodiment 400 presenting in FIG. 4. As was the case in FIG. 4, a match 420 may be detected after the identity 414 has evaluated the current segment of data in the data stream 214, in which case a match report 218B may be generated. However, in this sequence, rather than proceeding directly to the process step asking whether more data is required 428, the identity itself may have the opportunity to change the contents 704 of the pool of identities 204. If the identity 208 determines that a change to the pool of identities 204 is called for, based on a characteristic associated with the target content, as described herein, then the identity may provide direction for the addition or subtraction of identities from the identity pool 708. However, if no changes to the identity pool are required, then the process flow continues to process step 428, as is the case in embodiment 400 of FIG. 4.

In embodiments, the capability for an identity 208 to change the contents of the pool of identities 204 may allow for the reduction in the number of identities 208 required as a part of the pool of identities 204. For example, if the examination 210 of the start of the stream was able to determine that one of the Microsoft Office family of applications was present in the data stream 214, but not able to determine which specific application is was, may result in an initial population of the pool of identities 204 including identities associated with the examination of all members of the Microsoft Office family of applications. However, if a reduced set of identities 208, say even a single identity 208, could be inserted that could continue to evaluate 212 the data stream 214 for determination of which application was present, and then when determined, could add in the identities 208 only associated with that application, a significant reduction in the total number of identities 208 may be realized. And since the speed with which the process may proceed may be a function of how many identities 208 need to examine the segments of the data stream 214, any reduction in the number of identities 208 included in the pool of identities 204 may provide an increase in the speed of overall process.

In embodiments, the initial selection of a pool of identities 204 from the universe of identities 202 may increase the speed with which scanning of a stream of data 214 may proceed due to the reduction in the number of identities 208 required for evaluation, which may be as much as from the number of identities 208 in the universe of identities 202 to the number of identities 208 in the pool of identities 204. In embodiments, the subsequent reduction in the number of identities 208 in the pool of identities 204 due to the removal of identities 208 that do not find matches may additionally increase the speed with which scanning of the data stream 214 may proceed. In embodiments, the use of identities 208 to modify the contents of the pool of identities 204 may further reduce the number of identities 208 in the pool of identities 204, and thus further increase the speed of scanning a data stream 214 for target content.

In an embodiment of the invention, data may be scanned as it is streamed through a computing facility. The data may be intercepted and scanned in portions as it flows through the computing facility. The scanning process may perform an evaluation of the data through the use of a pool of identities. The pool of identities may be selected from a universe of identities to limit the number of identities to be used in the scan. The pool of identities may be selected based on an examination of a portion of the data stream. By intelligently limiting the number of identities used in the scan, the scan can be shortened and this can lead to a significant increase in the computing performance and/or bandwidth.

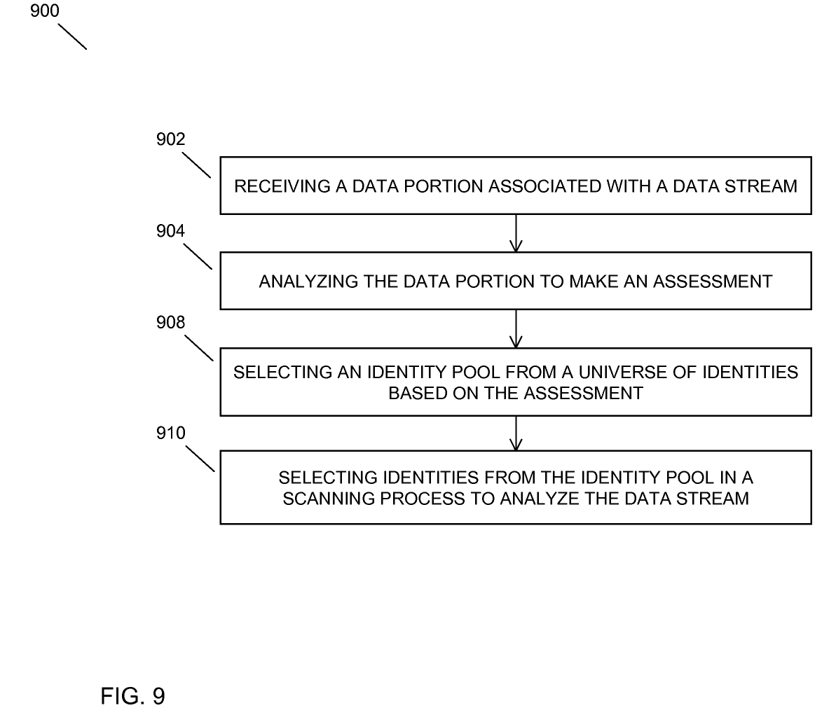

Referring to FIG. 9, in an embodiment 900, a data portion may be received associated with a data stream 902, and the data portion may be analyzed to make an assessment 904. An identity pool may then be selected from a universe of identities based on the assessment 908, and identities from the identity pool may be selected in a scanning process to analyze the data stream 910. Further, an unmatched identity may remove the identity form the pool upon finding that the unmatched identity may not match data in the data stream, and a matched identity may be removed from the identity pool upon finding that the matched identity matches data in the data stream.

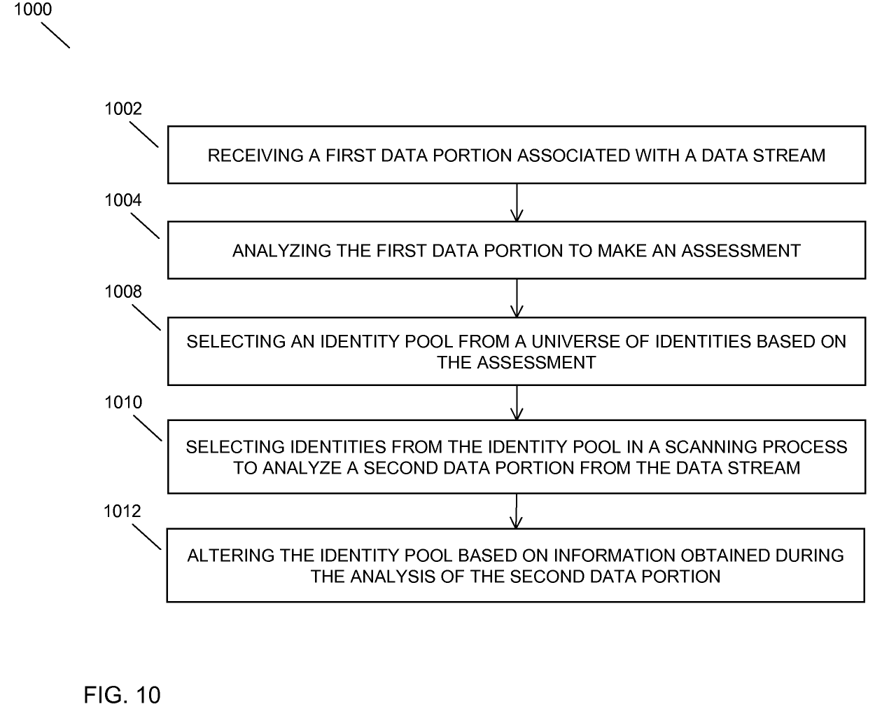

Referring to FIG. 10, in an embodiment 1000 of the invention, a first data portion may be received associated with a data stream 1002, and the data portion may be analyzed to make an assessment 1004. An identity pool may then be selected from a universe of identities based on the assessment 1008, and identities from the identity pool may be selected in a scanning process to analyze a second data portion from the data stream 1010. In addition, the identity pool may be altered based on information obtained during the analysis of the second data portion 1012, wherein the information obtained during the second data portion analysis may indicate the data stream is different from that projected when making the assessment based on the analysis of the first data portion In embodiments, altering the identity pool may involve adding new identities to the pool, removing identities from the pool, selecting a new identity pool, and the like. Further, an unmatched identity may remove the identity form the pool upon finding that the unmatched identity may not match data in the data stream, and a matched identity may be removed from the identity pool upon finding that the matched identity matches data in the data stream.

In embodiments, the scanning process may analyze each byte of the data stream, a plurality of byte portions from the data stream, a pattern of bytes from the data stream, and the like. In embodiments, the identity may be a byte code, where the process of scanning may involve executing the identities in the identity pool, at least one identity executing a matching process, at least one identify executing a hashing process, and the like. At least one identity may execute a determination process, wherein a decision about the data stream may be made following its execution. In embodiments, the identity may be a data pattern, where the process of scanning may involve comparing the identities in the identity pool to data from the data stream. In embodiments, the scanning process may be attempting to identify malware, identify information in accordance to a corporate policy, identify a file, and the like.

The elements depicted in flow charts and block diagrams throughout the figures imply logical boundaries between the elements. However, according to software or hardware engineering practices, the depicted elements and the functions thereof may be implemented as parts of a monolithic software structure, as standalone software modules, or as modules that employ external routines, code, services, and so forth, or any combination of these, and all such implementations are within the scope of the present disclosure. Thus, while the foregoing drawings and description set forth functional aspects of the disclosed systems, no particular arrangement of software for implementing these functional aspects should be inferred from these descriptions unless explicitly stated or otherwise clear from the context.

Similarly, it will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods or processes described above, and steps thereof, may be realized in hardware, software, or any combination of these suitable for a particular application. The hardware may include a general-purpose computer and/or dedicated computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as computer executable code created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software.

Thus, in one aspect, each method described above and combinations thereof may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. In another aspect, means for performing the steps associated with the processes described above may include any of the hardware and/or software described above. All such permutations and combinations are intended to fall within the scope of the present disclosure.

While the invention has been disclosed in connection with the preferred embodiments shown and described in detail, various modifications and improvements thereon will become readily apparent to those skilled in the art. Accordingly, the spirit and scope of the present invention is not to be limited by the foregoing examples, but is to be understood in the broadest sense allowable by law.

All documents referenced herein are hereby incorporated by reference.

What is claimed is:

1. A method, comprising:
receiving a data portion associated with a data stream;
analyzing the data portion to make an assessment;
selecting an identity pool from a universe of identities based on the assessment; and
selecting identities from the identity pool in a scanning process to analyze the data stream.

2. The method of claim 1, further comprising removing an unmatched identity from the identity pool upon finding that the unmatched identity does not match data in the data stream.

3. The method of claim 1, further comprising removing a matched identity from the identity pool upon finding that the matched identity matches data in the data stream.

4. The method of claim 1, wherein the scanning process analyzes each byte of the data stream.

5. The method of claim 1, wherein the scanning process analyzes a plurality of byte portions from the data stream.

6. The method of claim 1, wherein the scanning process analyzes a pattern of bytes from the data stream.

7. The method of claim 1, wherein the identity is byte code.

8. The method of claim 7, wherein the process of scanning involves executing the identities in the identity pool.

9. The method of claim 7, wherein at least one identity executes a matching process.

10. The method of claim 7, wherein at least one identity executes a hashing process.

11. The method of claim 7, wherein at least one identity executes a determination process, wherein a decision about the data stream can be made following its execution.

12. The method of claim 1, wherein the identity is a data pattern.

13. The method of claim 12, wherein the process of scanning involves comparing the identities in the identity pool to data from the data stream.

14. The method of claim 1, wherein the scanning process is attempting to identify malware.

15. The method of claim 1, wherein the scanning process is attempting to identify information in accordance to a corporate policy.

16. The method of claim 1, wherein the scanning process is attempting to identify a file.

17. A system, comprising:
a data portion associated with a data stream;
an assessment facility for analyzing the data portion;
the assessment facility selecting an identity pool from a universe of identities based on analysis from the assessment facility; and
the assessment facility selecting identities from the identity pool for scanning in order to analyze the data stream.

18. The system of claim 17, further comprising the assessment facility removing an unmatched identity from the identity pool upon finding that the unmatched identity does not match data in the data stream.

19. The system of claim 17, further comprising the assessment facility removing a matched identity from the identity pool upon finding that the matched identity matches data in the data stream.

20. The system of claim 17, wherein the scanning analyzes each byte of the data stream.

21. The system of claim 17, wherein the scanning analyzes a plurality of byte portions from the data stream.

22. The system of claim 17, wherein the scanning analyzes a pattern of bytes from the data stream.

23. The system of claim 17, wherein the identity is byte code.

24. The system of claim 23, wherein the scanning involves executing the identities in the identity pool.

25. The system of claim 23, wherein at least one identity executes a matching process.

26. The system of claim 23, wherein at least one identity executes a hashing process.

27. The system of claim 23, wherein at least one identity executes a determination, wherein a decision about the data stream can be made following its execution.

28. The system of claim 17, wherein the identity is a data pattern.

29. The system of claim 28, wherein the scanning involves comparing the identities in the identity pool to data from the data stream.

30. The system of claim 17, wherein the scanning is attempting to identify malware.

31. The system of claim 17, wherein the scanning is attempting to identify information in accordance to a corporate policy.

32. The system of claim 17, wherein the scanning is attempting to identify a file.
